(19) United States
(12) Patent Application Publication
(10) Pub. No.: US 2010/0114820 A1
(43) Pub. Date: May 6, 2010

(54) ELECTRONIC LIBRARY BOOK

(75) Inventor: Naveen Mathews, Singapore (SG)

Correspondence Address: IBM CORP (YA);C/O YEE & ASSOCIATES PC, P.O. BOX 802333, DALLAS, TX, 75380, US

(73) Assignee: INTERNATIONAL BUSINESS MACHINES CORPORATION, Armonk, NY (US)

(21) Appl. No.: 12/258,909

(22) Filed: Oct. 27, 2008

(51) Int. Cl. G06F 17/30; G06F 3/048

(52) U.S. Cl. 707/621; 715/764; 707/E17.044; 707/E17.014

(57) ABSTRACT

A computer implemented method and computer program product are presented for accessing items from a library. The computer-implemented method and program product comprises receiving a connection from a portable media storage device to an electronic check out device at the library. A search request is received from a user for an item in the library available in digital format. A screen is presented to the user with information about the item and a date of expiration. The item is downloaded to the portable media storage device. The item for viewing on the portable media storage device is presented for a definite period of time. The user is provided with a reminder to renew the item prior to the date of expiration.

### BACKGROUND OF THE INVENTION

1. Field of the Invention

The illustrative embodiments relate generally to a data processing system for accessing items from a library. Still more particularly, the illustrative embodiments are directed to a computer implemented method, program product, and system for accessing library materials, whereby the library materials may be downloaded to a portable storage media device provided to a user by the library.

2. Description of the Related Art

Currently, when a user at a library wants to a borrow a book, there are only a limited number of ways to do so. The user may go directly to a library, search for an item, and check-out with the actual item in hand. Unfortunately, items are sometimes lost by the borrower or mishandled when a user has physical possession of an item. Indeed, for this reason, many libraries do not allow a user to check-out a certain portion of the library's items outside the confines of a library.

Electronic access to printed material is also an option available to users at some libraries that have catalogued and structured a data processing system to allow a user to download printed material from a website. Usually, the user is required to view the printed material from a network computer within a library. Some libraries permit a user to download a copy of the printed material to the user's personal laptop or computer. A disadvantage with this method is that many users may not own a personal computer and/or laptop. The illustrative embodiments recognize an alternate method for accessing printed material and other items available from a library.

### BRIEF SUMMARY OF THE INVENTION

According to one embodiment of the present illustrative embodiments, a computer implemented method and computer program product are presented for accessing items from a library. The computer-implemented method and program product comprises receiving a connection from a portable media storage device to an electronic check out device at the library. A search request is received from a user for an item in the library available in digital format. A screen is presented to the user with information about the item and a date of expiration. Responsive to an indication of acceptance to download the item, the item is downloaded to the portable media storage device. The item for viewing on the portable media storage device is presented for a definite period of time. The user is provided with a reminder to renew the item prior to the date of expiration. The item is retained on the portable media storage device with a new time stamp and a new date of expiration responsive to an indication to renew the item.

### BRIEF DESCRIPTION OF THE SEVERAL VIEWS OF THE DRAWINGS

The novel features believed characteristic of the illustrative embodiments are set forth in the appended claims. The illustrative embodiments itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented.

FIG. 2 is a block diagram of a data processing system in which illustrative embodiments may be implemented.

FIG. 3 is a block diagram illustrating components of a data processing system for accessing and downloading items from a library onto a portable media storage device in accordance with an illustrative embodiment.

FIG. 4 is a pictorial representation of a portable media storage device in accordance with an illustrative embodiment.

FIG. 5 is a screen shot of a page providing information to a user regarding an item available for downloading in accordance with an illustrative embodiment.

FIG. 6 is a flowchart illustrating a method for downloading items from a library in accordance with an illustrative embodiment.

### DETAILED DESCRIPTION OF THE INVENTION

As will be appreciated by one skilled in the art, the illustrative embodiments may be embodied as a system, method or computer program product. Accordingly, the illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the illustrative embodiments may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the illustrative embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The illustrative embodiments are described below with reference to flowchart illustrations and/or block diagrams of methods, apparatus (systems) and computer program products according to embodiments of the illustrative embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Networked data processing system 100 is a network of computers in which different illustrative embodiments may be implemented. Networked data processing system 100 contains network 102, which is the medium used to provide communication links between various devices and computers connected within networked data processing system 100. Network 102 may include permanent or temporary connections, and wireless or land line connections. In the depicted example, servers 104 and 106 are connected to network 102, along with storage unit 108. In addition, clients 112 and 114 are also connected to network 102. Electronic check out device 110 allows a user to download items from a library onto a portable media storage device in accordance with an illustrative embodiment.

In the depicted example, server 104 provides data, such as boot files, operating system images and applications, to clients 112 and 114. Clients 112 and 114 are clients to server 104 and 106. Networked data processing system 100 may include additional servers, clients, and other devices not shown.

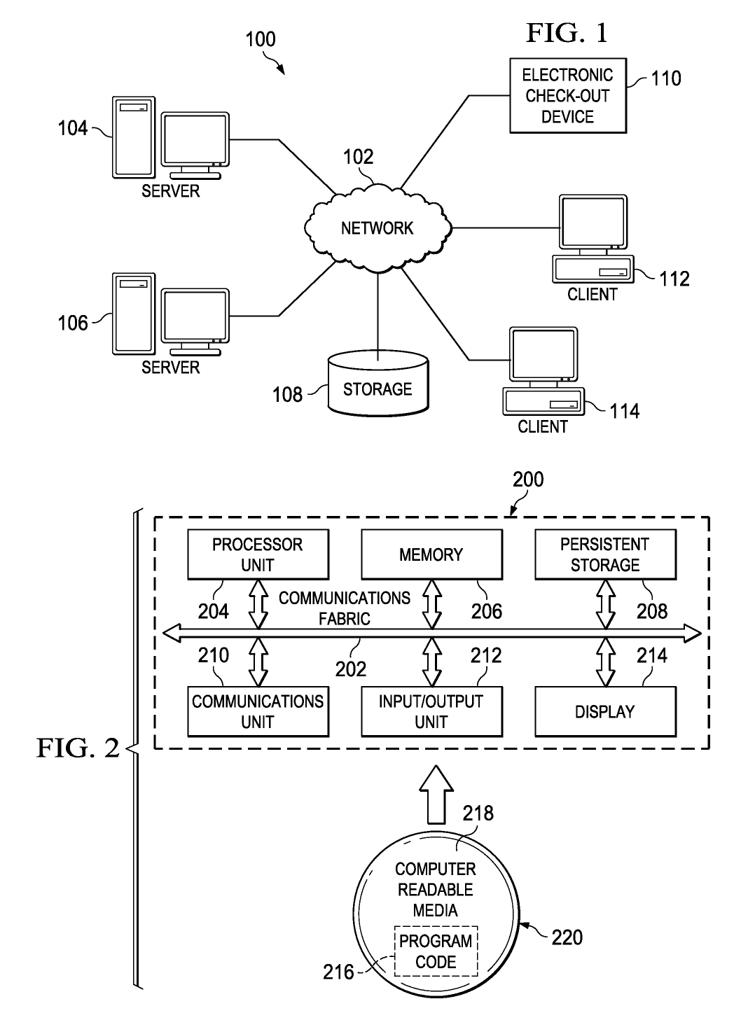

In the depicted example, networked data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, networked data processing system 100 also may be implemented as a number of different types of networks such as, for example, an Intranet or a local area network. FIG. 1 is intended as an example and not as an architectural limitation for the processes of the different illustrative embodiments.

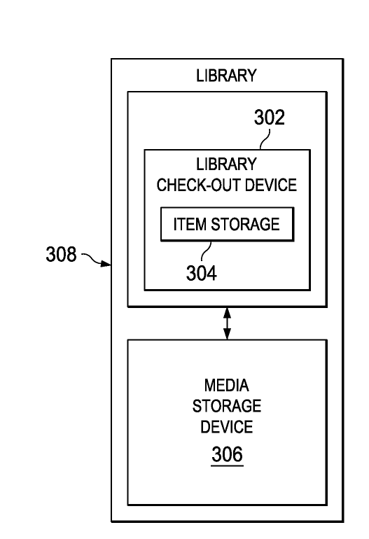

Turning now to FIG. 2, a diagram of a data processing system is depicted in accordance with an illustrative embodiment. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user. Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer readable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. As one example, a storage device in data processing system 200 is any hardware apparatus that may store data. Memory 206, persistent storage 208 and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202

Many people use libraries to access needed items. Typically, in order to be granted the privilege of access to the items, a user is required to have verifying information and proof of membership to a library. Members are usually allowed to check-out and borrow items for a limited period of time. However, there are occasions where a library may restrict access to certain items contained within their records for various reasons. For example, if an item is considered to be rare and valuable, most libraries will restrict a member to only being able to access the item within the confines of the library.

Some libraries have established electronic copies of items that are downloadable by their users to either network computers or personal computers. However, many libraries have chosen not to do so for multiple reasons. One reason may be fear of copyright infringement due to misuse through duplication and distribution without proper authorization. Therefore, many libraries have still not fully utilized the availability of electronic databases for uploading all of the items retained in their possession. Another problem is that not all members have access to or own their own personal computers and/or laptops for viewing the items online or electronically.

Thus, there is a need for an alternate method to view and borrow items from a library for a definite period of time. The illustrative embodiments recognize a need for a computer-implemented method, program product, and apparatus for downloading items onto a portable media storage device from a library. In one embodiment, a search request is received for an item located in library records on an electronic device. The electronic device connects to a portable media storage device using a connector. The item is then downloaded onto the portable media storage device. The portable media storage device is provided to a user by the library. A date of expiration is attached to the item after which the item becomes unavailable for viewing by the user unless the item is renewed.

FIG. 3 is a block diagram illustrating components of a data processing system for accessing and downloading items from a library onto a portable media storage device in accordance with an illustrative embodiment. FIG. 3 includes library check-out device 302. Library check-out device 302 is an electronic device that contains a library's electronic copies of any items available to a user to borrow from a library, such as library 308. Library 308 is a building or institution in charge of the collection of printed material or other items available to the public. As typical to most libraries, library 308 requires membership from users before allowing a member of the public to borrow an item.

Library check-out device 302 allows a user to download items for check-out onto media storage device 306. Media storage device 306 is available to a user to buy or borrow as part of the user's membership with library 308. Items available for downloading include, without limitation, printed and audiovisual material. Printed material may refer to any number of books, magazine articles, newspapers, and includes text and/or pictures. Audiovisual material may refer to movies, songs, television shows, news shows. Additionally, audiovisual material may include books recorded with accompanying audio and visual material such as “books on tape”.

Prior to a user downloading an item onto media storage device 306, library 308 purchases an item in physical or digital form. If the item is in physical form, then library 308 may scan the pages and save the item in a digital format. Library 308 may track the number of copies loaned out of the item. Library 308 stores the digital data in item storage 304. A digital copy of the items available from library 308 is located in item storage 304. In this illustrated embodiment, item storage 304 is included within library check-out device 302.

Media storage device 306 is portable. Media storage device 306 is also provided to a user by the library. A user may provide proof of membership when requesting media storage device 306.

Media storage device 306 may be powered using an electrical cord and an electrical outlet. In addition to electrical outlets in building, adapters may be included in some embodiments for recharging media storage device 306 in a vehicle or any other form of transportation. In another embodiment, media storage device 306 is powered through the use of commercial batteries. Media storage device 306 provides a warning to a user when the power of the device is running low or about to turn off.

A user proceeds to library check-out device 302 with media storage device 306. Library check-out device 302 receives search requests from a user for an item. In a preferred embodiment, the user is only able to search library check-out device 302 for items that a user intends to download onto media storage device 306. The reason for only searching items on library check-out device 302 is that library check-out device 302 will have the most updated record of available items in their digital format. After locating the item, library check-out device 302 provides the user with a date of expiration for the item. Thus, a user is aware that the item is only available to be downloaded for a definite period of time on media storage device 306. Additionally, in one embodiment, library check-out device 302 requires membership information from a user to verify that a user has authorization to download and borrow the items from a library's records.

Media storage device 306 is connected to library check-out device 302 through a proprietary connector, such as a USB cord. In a preferred embodiment, a user is presented with an item information page that provides relevant information to a user about the item. The item information page includes a date of expiration for the item and provides the user with a selector for downloading the item onto media storage device 302. If a user chooses to download the item, the item is downloaded along with a timestamp. A timestamp is implanted into media storage device 306 during the download process. A timestamp is data included in a digital format that provides the date and time the item is downloaded onto media storage device 306. An original timestamp is included with item during the initial downloading process on media storage device 306. If a user chooses to renew the item at the library using library check-out device 302, then a new timestamp and a new date of expiration will be implanted during the downloading process as part of the renewal.

As part of the checkout process, a database belonging to library 308 is updated with the number of copies downloaded of any particular item, which will allow librarians and management in a library, such as library 308, to keep track of the number of digital copies released electronically via media storage device 306 at any one time, in order to help prevent unauthorized copies.

After a definite period of time, the item will be unavailable for viewing on media storage device 306. Software is included on media storage device 306 for viewing the data, storing the data based on the timestamp, and then erasing the data on the date of expiration so that the data is no longer available to a user.

A user has the option of renewing the item either on or before the date of expiration. In one embodiment, media storage device 306 provides a visual and/or audio reminder to a user to renew the item. The reminder may be configured to be presented to a user at a certain length of time prior to the date of expiration on media storage device 306. In another embodiment, the library may send an e-mail reminder to a user's e-mail account regarding the approaching date of expiration.

A user may update membership information on media storage device 306. Additionally, a user may renew the item on media storage device 306 on or before the date of expiration. Once the item is downloaded to media storage device 306, the item cannot be copied from media storage device 306. This characteristic of the illustrative embodiment helps to ensure copyright protection of the item since the item cannot be duplicated and distributed beyond media storage device 306 without proper authorization.

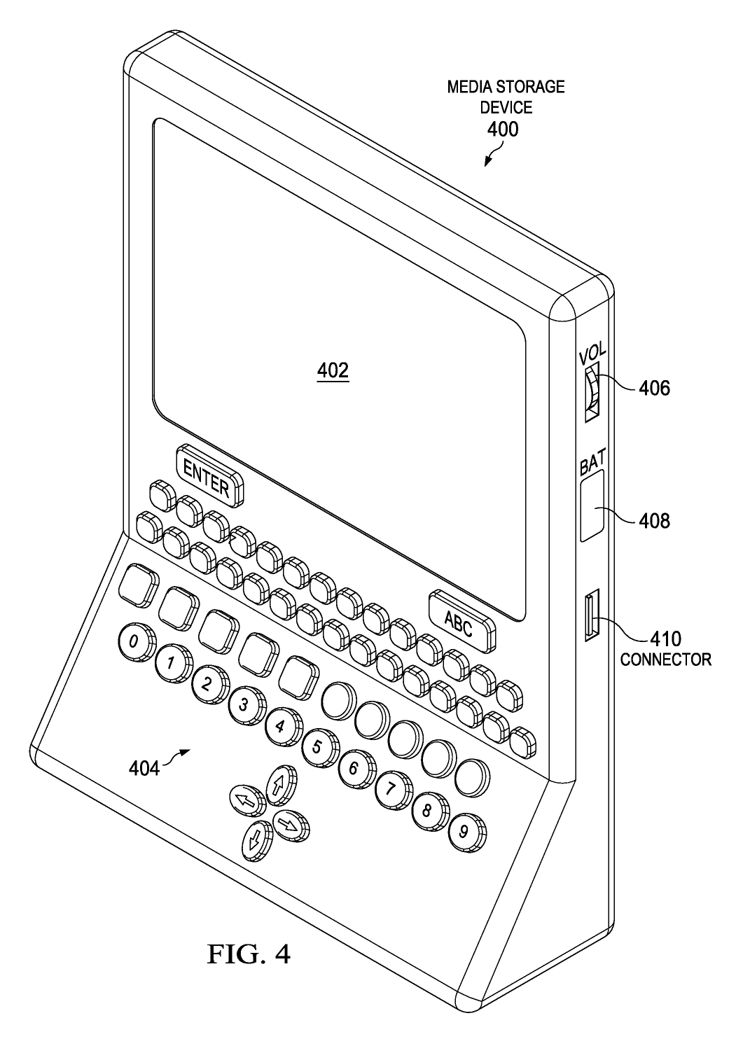

FIG. 4 is a pictorial representation of portable media storage device in accordance with an illustrative embodiment. Media storage device 400 is included in FIG. 4. Media storage device 400 is another example of a portable media storage device, as is media storage 306 in FIG. 3. In one illustrative embodiment, media storage device 400 includes a screen, as seen by screen 402, for viewing items downloaded from an electronic device in a library. An example of such an electronic device is library check-out device 302 in FIG. 3. Screen 402 on media storage device 400 may also include background lighting for use in poor lighting conditions. One of ordinary skill in the art is aware that media storage device 400 may be manufactured in a variety of sizes, colors, and with a variety of designs and materials.

FIG. 4 includes volume 406 which allows a user to adjust the volume. Items that may be downloaded include audio-visual content or items available solely in an audio format. Connector 410 is a location for media storage device 400 to be connected to a library check-out device, such as library check-out device 302 in FIG. 3. This illustrative embodiment includes keypad 404 which provides selectors for a user to manipulate the contents located on screen 402. Keypad 404 is an alphanumeric keypad and allows a user to type in information responsive to prompts on screen 402.

A user may need to use keypad 404 in order to renew an item on or before the date of expiration. In one embodiment, the renewal process requires connecting media storage device 400 to library check-out device 302 in FIG. 3, as the records in library check-out device 302 will need to be updated. A library can limit the number of copies available for downloading onto a media storage device. Thus, the library records need to be updated to reflect the number of copies downloaded at any point in time. In another embodiment, an unlimited number of copies of an item may be downloaded to various media storage devices, such as media storage device 400, at any one time.

Media storage device 400 also allows a user to adjust the size of text and/or pictures located on screen 402 by reducing or enlarging the size through an embedded magnification and reduction tool.

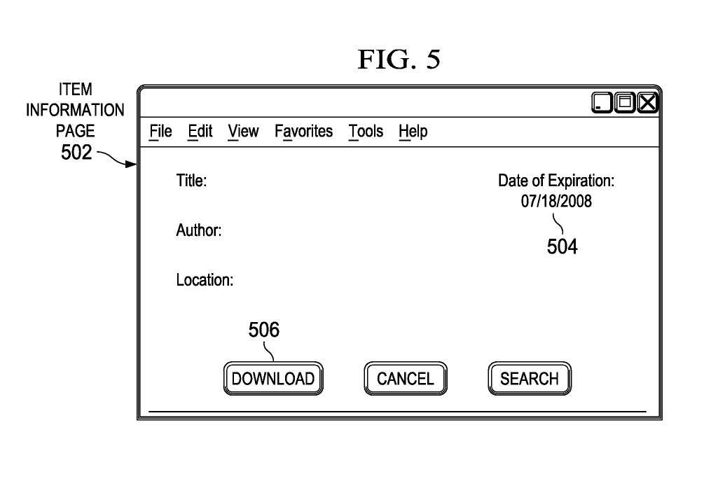

FIG. 5 is a screen shot of a page providing information to a user regarding an item available for downloading in accordance with an illustrative embodiment. Item information page 502 is an example of a summary that appears to a user on a library check-out device, such as library check-out device 302 in FIG. 3. Item information page 502 includes relevant information to a user about an item that is available for downloading from a library, such as library 308 in FIG. 3. A date of expiration is included for a user, as seen by date of expiration 504. A user connects a portable media storage device, such as media storage device 306 in FIG. 3 and media storage device 400 in FIG. 4. In a preferred embodiment, item information page 502 appears to a user prior to downloading. If a user wants to select the item for downloading, the user selects download 506. Other buttons may be included in item information page 502, such as “cancel” and “search, thus providing more options to a user for searching for other items. Item information page 502 may also include relevant information about the item. For example, if the downloaded item is a book or article, item information page 502 includes the tile, author, and location within the library of the book or the article.

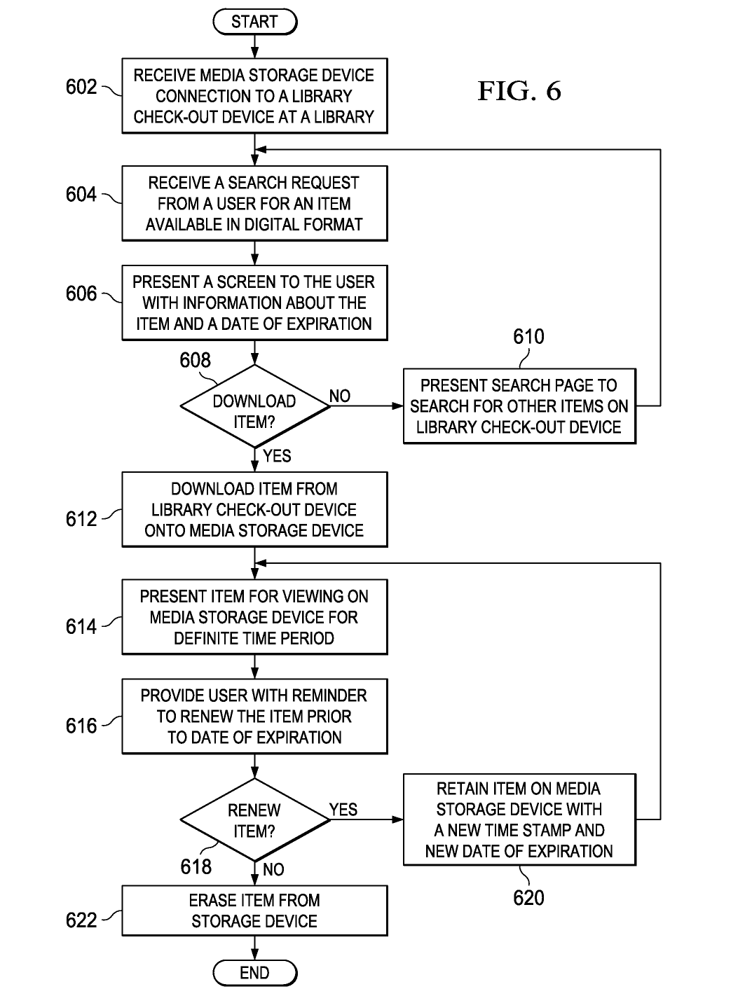

FIG. 6 is a flowchart illustrating a method for downloading items from a library in accordance with an illustrative embodiment. FIG. 6 describes a method using a library check-out device and a media storage device, such as library check-out device 302, and media storage device 306 from FIG. 3 and media storage device 400 in FIG. 4.

In an illustrative embodiment, the process receives a connection from a media storage device to a library check-out device at a library (step 602). A search request is received from a user for an item available in digital format (step 604). The process presents a screen to the user with information about the item and a date of expiration (step 606). In one embodiment, membership information is received on the library check-out device before authorizing any downloading of items in order to make sure the user is authorized to download information without any restrictions. A library may choose to place restrictions on a user and this will register on the screen prior to downloading the item onto the media storage device.

The process queries whether the user would like to download the item (step 608). If a user declines to download the item, the user is presented with a search page on the library check-out device in order to search for other items that may interest the user (step 610). The process then returns to step 604. If the user accepts to download the item, the item is downloaded onto a portable media storage device (step 612). The process then presents the item for viewing for a definite period of time (step 614).

Prior to the date of expiration, the user is provided with a reminder whether the user would like to renew the item (step 616). The process presents a query whether to renew the item (step 618). An item may be renewed by connecting the media storage device to a library check-out device.

If a user chooses to renew, the item is retained on the media storage device with a new timestamp marking the date of renewal and a new date of expiration (step 620). The process returns to step 614.

If the user declines to renew the item, the item is erased from the media storage player (step 622). The process terminates thereafter.

The illustrated embodiments present a method for users to access library items in digital format. The media storage device described herein provides users with a portable and more convenient method of viewing items from a library. The library is also provided with protection since the portable media storage device prohibits any form of copying of an item from the portable media storage device. Additionally, the library has the ability to protect valuable items that are not allowed to be released in an original format, while still making available to the public the same item, only in a digital format.

Furthermore, the illustrative embodiments describe features such as reminders prior to date of expiration and the ability to renew using the portable media storage device that will make checking out items from a library easier and much more convenient than current methods.

The illustrative embodiments can take the form of an entirely hardware embodiment, an entirely software embodiment or an embodiment containing both hardware and software elements. In a preferred embodiment, the illustrative embodiments are implemented in software, which includes but is not limited to firmware, resident software, microcode, etc.

Furthermore, the illustrative embodiments can take the form of a computer program product accessible from a computer-usable or computer-readable medium providing program code for use by, or in connection with, a computer or any instruction execution system. For the purposes of this description, a computer-usable or computer readable medium can be any recordable-type tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the illustrative embodiments has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer-implemented method for accessing items from a library, the computer implemented method comprising:
receiving a connection from a portable media storage device to an electronic check out device at the library;
receiving a search request from a user for an item in the library available in a digital format;
presenting a screen to the user with information about the item and a date of expiration;
responsive to an indication of acceptance to download the item, downloading the item to the portable media storage device;
presenting the item for viewing on the portable media storage device for a definite period of time;
providing the user with a reminder to renew the item prior to the date of expiration; and
responsive to an indication to renew the item, retaining the item on the portable media storage device with a new time stamp and a new date of expiration.

2. The computer-implemented method of claim 1, further comprising:
requesting membership verification prior to downloading the item onto the portable media storage device.

3. The computer-implemented method of claim 1, wherein the portable media storage device contains selectors for manipulating the item.

4. The computer-implemented method of claim 1, further comprising:
connecting the electronic check-out device to the portable media storage device, wherein the electronic check-out device is a library check-out device.

5. The computer-implemented method of claim 1, wherein an original timestamp date is included during the downloading step of the item onto the portable media storage device.

6. The computer-implemented method of claim 1, wherein quantity of the item for check-out at the library is updated when the item is downloaded.

7. The computer-implemented method of claim 1, wherein the item cannot be copied from the portable media storage device.

8. The computer-implemented method of claim 1, further comprising:
automatically deleting the item from the portable media storage device at the date of expiration.

9. The computer-implemented method of claim 1, wherein the portable media storage device comprises a keyboard and a battery.

10. The computer-implemented method of claim 1, wherein the item comprises text, pictures, and audio-visual materials.

11. A computer program product stored on a recordable-type computer readable medium for accessing items from a library, the computer program product comprising:
computer program code for receiving a connection from a portable media storage device to an electronic check-out device at the library;
computer program code for receiving a search request for an item in a library available in a digital format;
computer usable program code for presenting a screen to the user with information about the item and a date of expiration;
computer usable program code for downloading the item to the portable media storage device, responsive to an indication of acceptance to download the item;
computer usable program code for presenting the item for viewing on the portable media storage device for a definite period of time;
computer usable program code for providing the user with a reminder to renew the item prior to the date of expiration; and
computer usable program code for retaining the item on the portable media storage device with a new time stamp and a new date of expiration.

12. The computer program product of claim 11, further comprising:
computer program code for requesting membership verification prior to downloading the item onto the portable media storage device.

13. The computer program product of claim 11, wherein the portable media storage device contains selectors for manipulating the item.

14. The computer program product of claim 11, further comprising:
computer program code for connecting the electronic check-out device to the portable media storage device, wherein the electronic check-out device is a library check-out device.

15. The computer program product of claim 11, wherein an original timestamp date is included during the downloading step of the item onto the portable media storage device.

16. An apparatus for accessing items from a library, the apparatus comprising
a bus system;
a storage device connected to the bus system, wherein computer useable program code is stored on the storage device; and
a processing unit connected to the bus system, wherein the processing unit is adapted to receive a connection from a portable media storage device to an electronic check-out device at the library; to receive a search request from a user for an item in a library available in digital format; to present a screen to the user with information about the item and a date of expiration; to download the item to the portable media storage device responsive to an indication of acceptance to download the item; to present the item for viewing on the portable media storage device for a definite period of time; to provide the user with a reminder to renew the item prior to the date of expiration; and to retain the item on the portable media storage device with a new time stamp and a new date of expiration.

17. The apparatus of claim 16, further comprising:
requesting membership verification prior to downloading the item onto the portable media storage device.

18. The apparatus of claim 16, wherein the portable media storage device contains selectors for manipulating the item.

19. The apparatus of claim 16, further comprising:
connecting the electronic check-out device to the portable media storage device, wherein the electronic check-out device is a library check-out device.

20. The apparatus of claim 16, wherein an original timestamp date is included during the downloading step of the item onto the portable media storage device.
